(19) United States
(12) Patent Application Publication
(10) Pub. No.: US 2010/0013292 A1
(43) Pub. Date: Jan. 21, 2010

(54) Seat belt retractor

(75) Inventor: Kenji Osada, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 12/320,690

(22) Filed: Feb. 2, 2009

(30) Foreign Application Priority Data
Jul. 18, 2008 (JP) 2008-187281

(51) Int. Cl. B60R 22/405; B65H 75/48; B60R 22/36; B65H 75/30; B60R 22/415

(52) U.S. Cl. 297/478; 242/396.2

(57) ABSTRACT

A seat belt retractor including an emergency locking retractor mechanism for locking the rotation in the belt withdrawing direction of a spool, onto which a seat belt is wound, according to actuation of at least one of the deceleration sensing system and a webbing sensor; an automatic locking retractor for locking the rotation in the belt withdrawing direction of the spool when the seat belt is withdrawn by a predetermined length; and a lock switching mechanism for switching and setting between a mode exhibiting the emergency locking retractor mechanism and a mode exhibiting the automatic locking retractor mechanism. The lock switching mechanism includes an automatic locking retractor mechanism actuating lock member, and an automatic locking retractor mechanism actuating lock gear which locks the rotation in the belt withdrawing direction of the spool when the automatic locking retractor mechanism actuating lock member is engaged.

### BACKGROUND

The present application relates to a technical field of a seat belt retractor, which has an automatic locking retractor mechanism (ALR mechanism) in addition to an emergency locking retractor mechanism (ELR mechanism), and a seat belt apparatus having the seat belt retractor.

Conventionally, a seat belt apparatus installed in a vehicle such as an automobile restrains an occupant with a seat belt in the event of an emergency so as to prevent the occupant from jumping out of a vehicle seat. Typically, the seat belt apparatus has a seat belt retractor. As such a seat belt retractor, many emergency locking retractors (ELR) are known.

When an extremely large deceleration acts on a vehicle in the event of a vehicle collision or the like, known ELRs as disclosed, for example, in Japanese Patent Applications JP-A-7-144605 and JP-A-7-144606 (both incorporated by reference herein), prevent rotation of a lock gear by that a deceleration sensing system of a vehicle sensor detects the deceleration. Then, rotation of a spool onto which a seat belt is wound is locked not to rotate in the belt withdrawing direction so that withdrawal of the seat belt from the retractor due to inertial movement of an occupant is prevented. Therefore, the occupant is restrained by the seat belt. By sudden withdrawal of the seat belt, an inertial delay of an inertia mass body of a webbing sensor is caused relative to the spool so that the inertia mass body is actuated. Then, an engaging claw of the inertia mass body engages one of internal teeth of an annular webbing sensor ratchet gear which is disposed on a retainer (cover), thereby locking the rotation in the belt withdrawing direction of the spool onto which the seat belt is wound and thus preventing further withdrawal of the seat belt.

On the other hand, many seat belt retractors having an automatic locking retractor mechanism (ALR mechanism) in addition to the ELR mechanism are also known. In an ALR disclosed in Japanese Patent Application JP-A-2001-213275 (incorporated by reference herein), a seat belt is prevented from being withdrawn from the retractor until the seat belt is wound up by the retractor after a preset length (for example, the entire length or substantially the entire length) of the seat belt is withdrawn from the seat belt retractor. As a preset length of the seat belt is wound up by the retractor, the retractor is returned from an ALR mechanism mode to an ELR mechanism mode. As an example of cases of using the ALR mechanism, there is a case for fixing a child seat to a vehicle seat.

Therefore, the seat belt retractor having the ELR mechanism and the ALR mechanism normally exhibits the ELR mechanism, but exhibits the ALR mechanism after the preset length of the seat belt is withdrawn.

The seat belt retractor disclosed in JP-A-2001-213275 is provided with an ALR actuating ratchet gear which rotates together with the spool and a blocking pawl which can engage one of external teeth of the ALR actuating ratchet gear to prevent the spool from rotating in the belt withdrawing direction when the seat belt retractor is set to exhibit the ALR mechanism. In this case, the blocking pawl is pivotally disposed so that the blocking pawl engages the ALR actuating ratchet gear by pivotal movement of the blocking pawl. The blocking pawl is disposed on a base frame such that the blocking pawl pivots about its one end between an inoperative position where the blocking pawl does not engage any of the external teeth of the ALR actuating ratchet gear and an operative position where the blocking pawl engages one of the external teeth of the ALR actuating ratchet gear. Accordingly, the blocking pawl is arranged outside of the annular webbing sensor ratchet gear for the purpose of ensuring enough space for pivotal movement. Therefore, the ALR actuating ratchet gear which the blocking pawl engages is also arranged outside of the webbing sensor ratchet gear.

However, it is difficult to stably control the operation of the blocking pawl when the blocking pawl is adapted to engage the ALR actuating ratchet gear by the pivotal movement of the blocking pawl. Further, the blocking pawl and the ALR actuating ratchet gear are arranged outside of the webbing sensor ratchet gear, thus inevitably increasing the size in the radial direction of the retractor. In addition, the ALR actuating ratchet gear must be attached to the spool at a position out of the webbing sensor ratchet gear in the axial direction of the spool to avoid interference between the ALR actuating ratchet gear and the webbing sensor ratchet gear, thus also increasing the size in the axial direction of the retractor. Especially in case that the blocking pawl is adapted to pivot, it is difficult to make the ELR-ALR switching mechanism compact.

Further, since the retractor needs a cam ring for detecting the rotation of the spool as a trigger of switching from the ELR to the ALR or from ALR to the ELR and a blocking pawl control system which is activated by the cam ring to control the pivotal movement of the blocking pawl between the inoperative position and the operative position, thus not only increasing the number of parts but also making the structure complex.

In view of the aforementioned devices, an object a disclosed embodiment is to provide a seat belt retractor, which has an emergency locking retractor mechanism and an automatic locking retractor mechanism and which has a reduced number of parts and thus has simple structure and can be made compact, and a seat belt apparatus having the same.

### SUMMARY

One embodiment relates to a seat belt retractor comprising: an emergency locking retractor mechanism for locking the rotation in the belt withdrawing direction of a spool, onto which a seat belt is wound, according to actuation of at least one of the deceleration sensing system and a webbing sensor. The seat belt retractor further comprises an automatic locking retractor for locking the rotation in the belt withdrawing direction of the spool when the seat belt is withdrawn by a predetermined length and a lock switching mechanism for switching and setting between a mode exhibiting the emergency locking retractor mechanism and a mode exhibiting the automatic locking retractor mechanism. The lock switching mechanism comprises an automatic locking retractor mechanism actuating lock member, and an automatic locking retractor mechanism actuating lock gear which locks the rotation in the belt withdrawing direction of the spool when the automatic locking retractor mechanism actuating lock member is engaged. The automatic locking retractor mechanism actuating lock member is engaged with and is disengaged from the automatic locking retractor mechanism actuating lock gear by linear movement.

Another embodiment relates to a seat belt apparatus comprising a seat belt retractor, a tongue which is slidably supported on the seat belt withdrawn from the seat belt retractor, and a buckle which is detachably latched with the tongue. The seat belt is prevented from being withdrawn by the seat belt retractor in the event of an emergency so as to restrain an occupant.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is an illustration schematically showing a seat belt apparatus employing an embodiment of a seat belt retractor according to an exemplary embodiment.

FIG. 2 is a partial vertical sectional view showing the embodiment of the seat belt retractor according to an exemplary embodiment.

FIG. 3 is a sectional view taken along a line III-III in FIG. 2, showing a state in which an ELR mechanism mode is set.

FIG. 4 is a sectional view similar to FIG. 3, showing a state in which an ALR mechanism mode is set.

FIG. 5 is an illustration showing a retainer.

FIGS. 6(a)-6(c) show an eccentric cam, wherein FIG. 6(a) is a front view thereof, FIG. 6(b) is a sectional view taken along a line VIB-VIB in FIG. 6(a), and FIG. 6(c) is a rear view thereof.

FIGS. 7(a)-7(c) show an external gear, wherein FIG. 7(a) is a front view thereof, FIG. 7(b) is a sectional view taken along a line VIIB-VIIB in FIG. 7(a), and FIG. 7(c) is a rear view thereof.

FIG. 8 is an illustration for explaining the rotation of the external gear according to the rotation of the eccentric cam.

FIGS. 9(a)-9(d) show an ALR actuating lock member, wherein FIG. 9(a) is a front view thereof, FIG. 9(b) is a right side view thereof, FIG. 9(c) is a rear view thereof, and FIG. 9(d) is a sectional view taken along a line IXD-IXD in FIG. 9(c).

FIG. 10 is a partial vertical sectional view showing another embodiment of the seat belt retractor according to an exemplary embodiment.

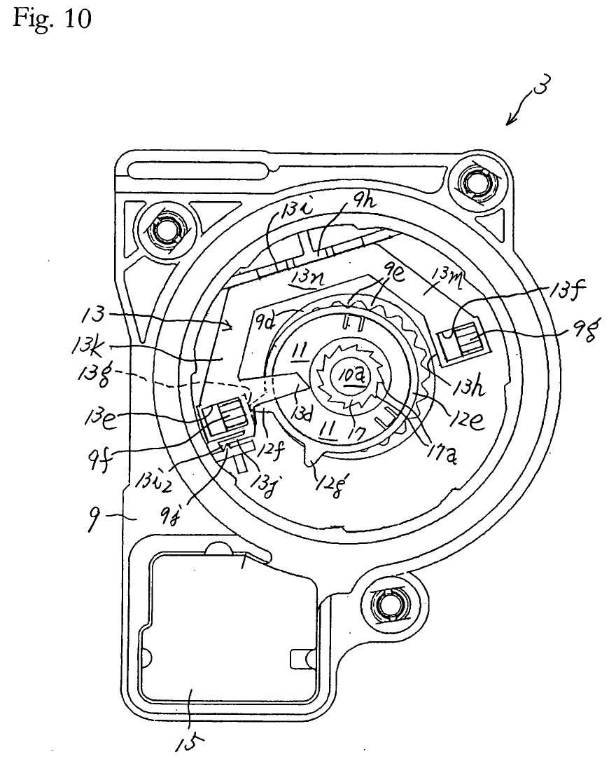

### DETAILED DESCRIPTION

According to one exemplary embodiment, a seat belt retractor comprises: an emergency locking retractor (ELR) mechanism for locking the rotation in the belt withdrawing direction of a spool, onto which a seat belt is wound, according to actuation of at least one of the deceleration sensing system and a webbing sensor; an automatic locking retractor (ALR) mechanism for locking the rotation in the belt withdrawing direction of the spool when the seat belt is withdrawn by a predetermined length; and a lock switching mechanism for switching and setting between a mode exhibiting the ELR mechanism and a mode exhibiting the ALR mechanism. The lock switching mechanism comprises an ALR mechanism actuating lock member, and an ALR mechanism actuating lock gear which locks the rotation in the belt withdrawing direction of the spool when the ALR mechanism actuating lock member is engaged. The ALR mechanism actuating lock member is engaged with and is disengaged from the ALR mechanism actuating lock gear by linear movement.

According to an exemplary embodiment, the lock switching mechanism is arranged inside an annular member of the ELR mechanism.

According to an exemplary embodiment, the seat belt retractor further comprises a guide member for guiding the ALR mechanism actuating lock member during the linear movement of the ALR mechanism actuating lock member.

According to an exemplary embodiment, the seat belt retractor further comprises an internal gear; and an external gear which is meshed with the internal gear and rotates eccentrically at a reduced speed according to the rotation of the spool. The external gear has an ELR mechanism setting switch and an ALR mechanism setting switch. The ALR mechanism actuating lock member is pressed by one of the ELR mechanism setting switch and the ALR mechanism setting switch so as to linearly move.

According to an exemplary embodiment, the ELR mechanism setting switch presses only an ELR mechanism setting pressed portion of the ALR mechanism actuating lock member so as to move the ALR mechanism actuating lock member linearly such that the ALR mechanism actuating lock member is disengaged from the ALR mechanism actuating lock gear. The ALR mechanism setting switch presses only an ALR mechanism setting pressed portion of the ALR mechanism actuating lock member so as to move the ALR mechanism actuating lock member linearly such that the ALR mechanism actuating lock member is engaged with the ALR mechanism actuating lock gear.

According to an exemplary embodiment, the external gear, the ELR mechanism setting switch, and the ALR mechanism setting switch are formed integrally as a single member.

According to an exemplary embodiment, the seat belt retractor further comprises a holding system which holds the ALR mechanism actuating lock member in its disengaged state when the ALR mechanism actuating lock member is disengaged from the ALR mechanism actuating lock gear. The holding system further holds the ALR mechanism actuating lock member in its engaged state when the ALR mechanism actuating lock member is engaged with the ALR mechanism actuating lock gear.

According to another exemplary embodiment, a seat belt apparatus comprises at least: a seat belt retractor which winds up a seat belt, a tongue which is slidably supported on the seat belt withdrawn from the seat belt retractor; and a buckle which is detachably latched with the tongue, wherein the seat belt is prevented from being withdrawn by the seat belt retractor in the event of an emergency so as to restrain an occupant.

According to the seat belt retractor and the seat belt apparatus having the aforementioned structures, the ALR mechanism actuating lock member is adapted to move linearly between the inoperative position and the operative position, whereby the movement of the ALR mechanism actuating lock member can be stably and more easily controlled and the ALR mechanism actuating locking mechanism can be more efficiently arranged inside the annular member of the ELR mechanism.

In addition, since the lock switching mechanism is composed of the ALR mechanism actuating lock member and the ALR mechanism actuating lock gear, the number of parts is reduced as compared to the ALR mechanism actuating locking mechanism disclosed in Japanese Patent Application JP-A-2001-213275 thereby making the structure simple and making the seat belt retractor at a lower cost.

Further, since the lock switching mechanism is arranged inside the annular member of the ELR mechanism, the seat belt retractor can be made in a small compact form.

Since the ALR mechanism actuating lock member is guided by the guide member during the linear movement of the ALR mechanism actuating lock member, the ALR mechanism actuating lock member can smoothly and stably move. Therefore, the engagement between the ALR mechanism actuating lock member and the ALR mechanism actuating lock gear is prevented from shifting in timing.

Further, since the external gear, the ELR mechanism setting switch, and the ALR mechanism setting switch are formed integrally as a single member, it is possible to make these structures simple. In addition, the ELR mechanism setting switch is adapted to press only the ELR mechanism setting pressed portion and the ALR mechanism setting switch is adapted to press only the ALR mechanism setting pressed portion, thereby eliminating the precise adjustment for the respective positions and heights of the ELR mechanism setting switch and the ALR mechanism setting switch. Accordingly, the ELR mechanism setting switch and the ALR mechanism setting switch can be easily manufactured.

Furthermore, the ALR mechanism actuating lock member can be held in the state disengaged from the ALR mechanism actuating lock gear and also can be held in the state engaged with the ALR mechanism actuating lock gear by the holding system, thereby stably holding the ALR mechanism actuating lock member in any of both setting positions.

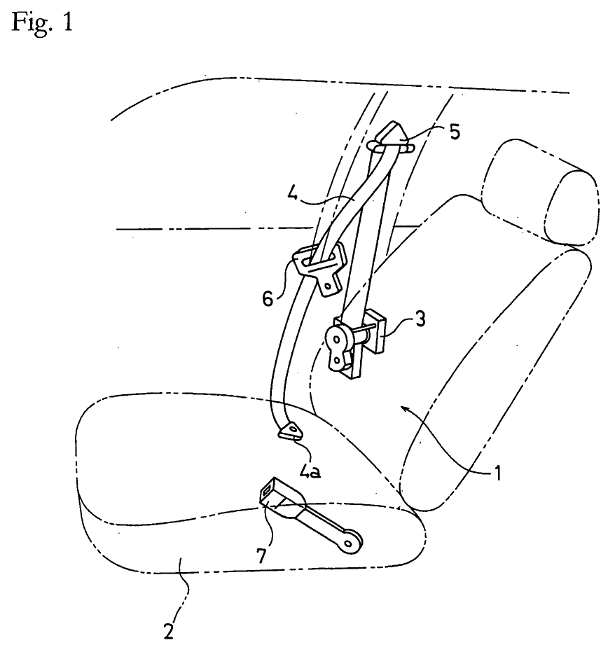

As shown in FIG. 1, the seat belt apparatus 1 of this embodiment is the same as a conventionally known seat belt apparatus of a three-point type. The seat belt apparatus 1 includes a vehicle seat 2, a seat belt retractor 3 which is arranged adjacent to the vehicle seat 2, a seat belt 4 which is wound by the seat belt retractor 3 in such a manner as to allow the withdrawal of the seat belt and is provided at its end with a belt anchor 4a fixed to a vehicle floor or the vehicle seat 2. The seat belt apparatus further includes a guide anchor 5 for guiding the seat belt 4 withdrawn from the seat belt retractor 3 toward an occupant's shoulder, a tongue 6 which is slidably supported on the seat belt 4 guided by and extending from the guide anchor 5, and a buckle 7 which is fixed to the vehicle floor or the vehicle seat and to which the tongue 6 can be inserted and detachably latched. The operation of taking on and off the seat belt 4 in the seat belt apparatus 1 is the same as the conventional seat belt apparatus.

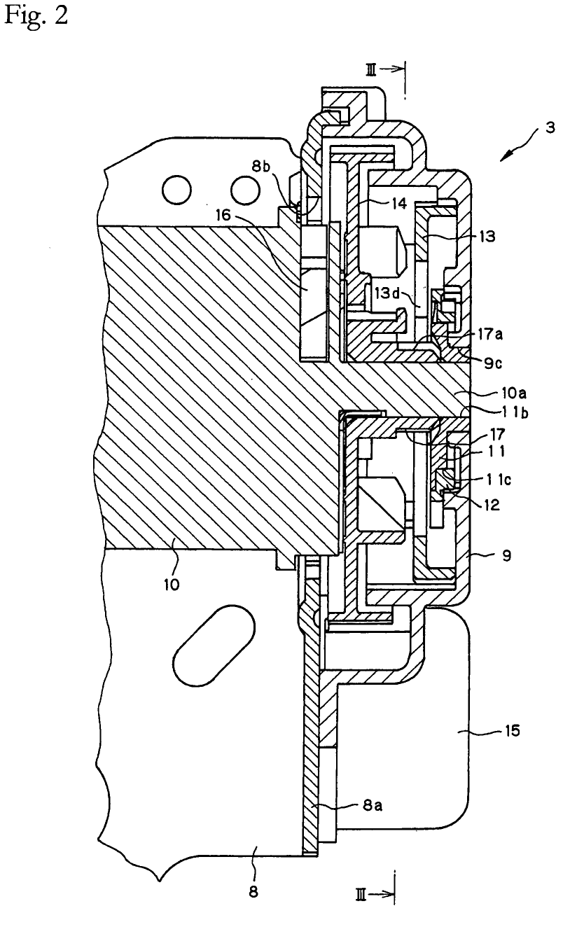

As shown in FIG. 2 through FIG. 4, the seat belt retractor 3 of this embodiment is a retractor having an ELR mechanism and an ALR mechanism. The seat belt retractor 3 comprises a U-like base frame 8 similarly to the conventional retractor. A retainer 9 is detachably attached to a side wall 8a of the base frame 8. Rotatably supported by the retainer 9 is a rotary shaft portion 10a as one end of the spool 10 onto which the seat belt 4 is wound. In this case, an eccentric cam 11 is attached to the rotary shaft portion 10a of the spool 10 in such a manner as to rotate together with the spool 10. The rotary shaft portion 10a is rotatably supported on the retainer 9 via the eccentric cam 11.

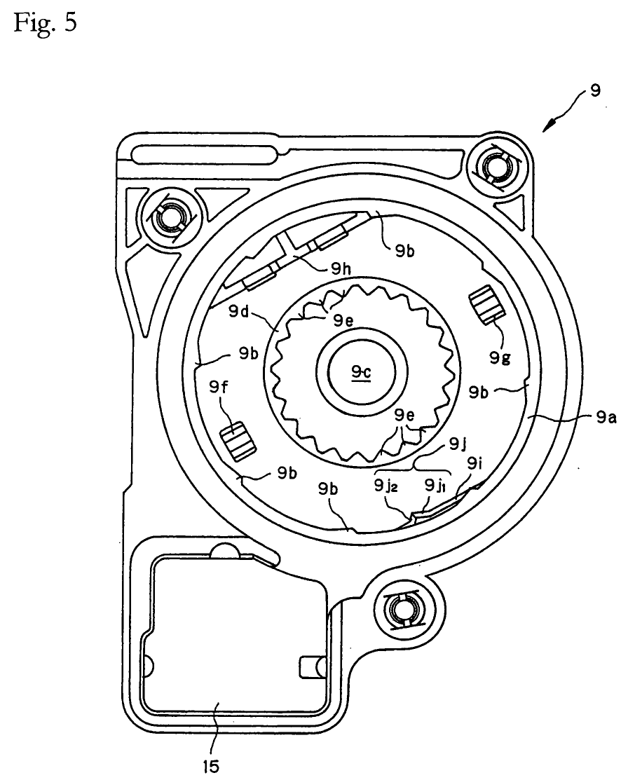

As shown in FIG. 5, the retainer 9 is provided with a webbing sensor ratchet gear 9a (e.g., annular member, W/S ratchet gear, etc.) for the ELR. The W/S ratchet gear 9a is formed into an annular shape and has a predetermined number (eight in the illustrated example) of ratchet teeth 9b which are arranged at equal intervals in the circumferential direction. The W/S ratchet gear 9a is similar to the ratchet gear described in Japanese Patent Applications JP-A-7-144605 and JP-A-7-144606.

The retainer 9 is also provided with a supporting hole 9c which is formed on an inner side of the W/S ratchet gear 9a and coaxially with the W/S ratchet gear 9a. Further, the retainer 9 is provided with an annular internal gear 9d which is formed between the supporting hole 9c and the W/S ratchet gear 9a and coaxially with the W/S ratchet gear 9a. The internal gear 9d has a predetermined number (twenty two in the illustrated example) of inner teeth 9e.

Furthermore, the retainer 9 is provided with a pair of guide projections 9f, 9g which are formed between the internal gear 9d and the W/S ratchet gear 9a and spaced from each other diametrically. The retainer 9 is also provided with a guide member 9h which extends parallel to a line connecting the guide projections 9f, 9g and with a position control member 9i which is formed on the side opposite to the guide member 9h relative to the line connecting the guide projections 9f, 9g. The position control member 9i has a substantially triangle-shaped stopper 9j. In this case, the right side in FIG. 5 of the triangle of the stopper 9j is a relatively gentle slope 9j1 and the left side in FIG. 5 of the triangle of the stopper 9j is a sharp slope 9j2 which is sharper than the right side.

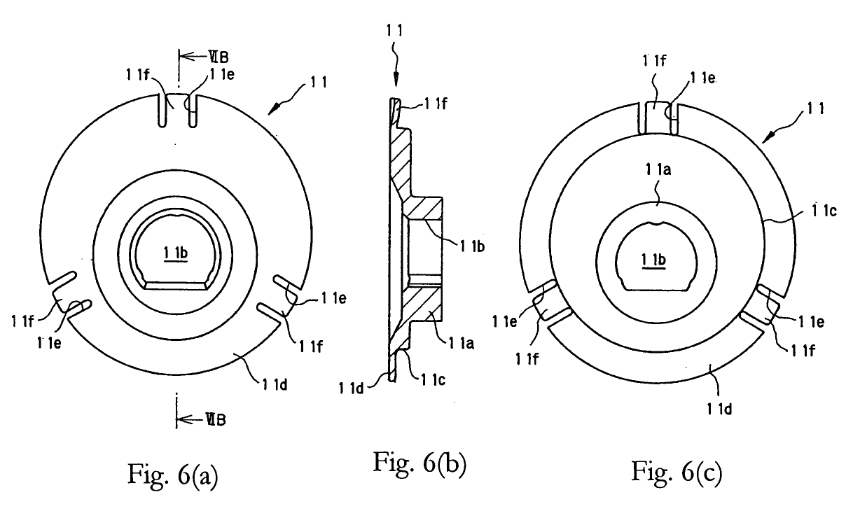

As shown in FIG. 6(a) through FIG. 6(c), the eccentric cam 11 has a rotary shaft portion 11a coaxially with the spool 10 and which is rotatably supported by the supporting hole 9c of the retainer 9 (see FIG. 2). The rotary shaft portion 11a is provided with an axial through hole 11b having an arc-shaped section. The rotary shaft portion 10a of the spool 10 is fitted in the axial through hole 11b such that the eccentric cam 11 is not allowed to rotate relative to the spool 10 (see FIG. 2). The eccentric cam 11 has a cam face 11c which is a circle eccentrically shifted from the center of the rotary shaft portion 11a. Further, the eccentric cam 11 has an annular flange portion 11d outside of the cam face 11c and is provided with a predetermined number (three in the illustrated example) of cutouts 11e formed in the flange portion 11d at equal intervals in the circumferential direction. Each cutout 11e is provided with an elastic supporting portion 11f. The rotary shaft portion 11a, the cam face 11c, the flange portion 11d, and the elastic supporting portions 11f are formed integrally as a single member.

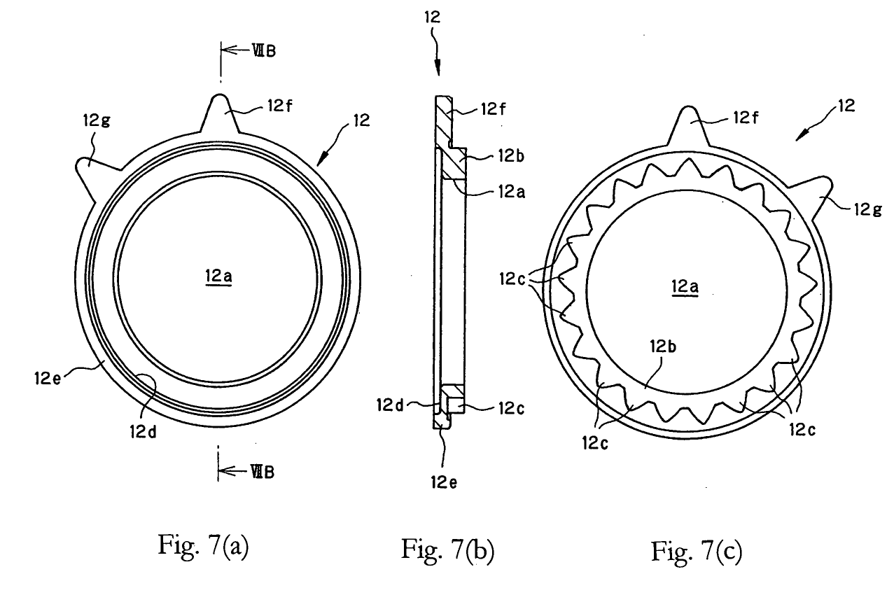

As shown in FIG. 2, an external gear 12 is supported on the cam face 11c of the eccentric cam 11 such that the external gear 12 can rotate relative to the eccentric cam 11. As shown in FIGS. 7(a) through 7(c), the external gear 12 is formed into an substantially annular plate-like shape and has a central through hole 12a which is fitted and supported by the cam face 11c such that the external gear 12 is allowed to slidably rotate relative to the cam face 11c. In the surface of the external gear 12 on the retainer 9 side, an annular external gear 12b is formed coaxially with the through hole 12a.

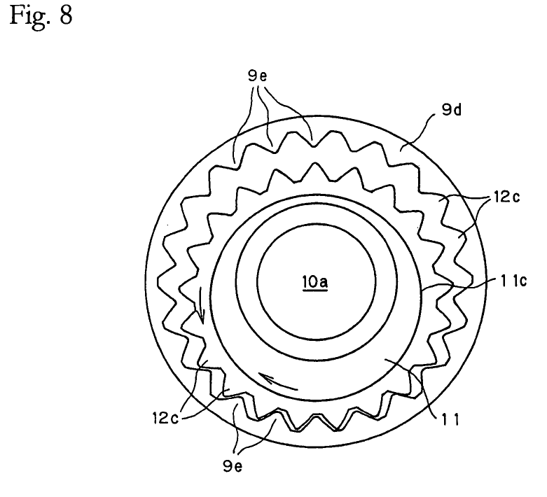

The external gear 12b has a predetermined number (twenty one in the illustrated example) of external teeth 12c of which number is smaller than that of the internal teeth 9e of the internal gear 9d. In this case, the outer diameter of the external gear 12 is set to be smaller than the inner diameter of the internal gear 9d. Therefore, as shown in FIG. 8, the external gear 12 is positioned on an inner side of the internal gear 9d and some of the external teeth 12c are meshed with some of the internal teeth 9e of the internal gear 9d. The meshed portion between the external teeth 12c and the internal teeth 9e is a range including the maximum eccentric portion of the cam face 11c of the eccentric cam 11. As the eccentric cam 11 rotates in the clockwise direction in FIG. 8 (that is, the belt withdrawing direction), the external gear 12 rotates in the counterclockwise direction, i.e. a direction opposite to the rotational direction of the eccentric cam 11, at a reduced speed.

In the surface on a side opposite to the retainer 9 side of the external gear 12, an annular concavity 12d and an annular flange 12e are formed coaxially with the through hole 12a. In this case, the external diameter of the annular flange 12e is set to be larger than the inner diameter of the internal gear 9d. Further, the external gear 12 is provided with an ELR setting switch 12f radially projecting from the annular flange 12e and is also provided with an ALR setting switch 12g which is spaced from the ELR setting switch 12f by a predetermined distance in the circumferential direction. The ends of the ELR and ALR setting switches 12f, 12g are both rounded. The external gear 12b and a pair of switches 12f, 12g are formed integrally as a single member.

In a state that the eccentric cam 11 and the external gear 12 are assembled as shown in FIG. 2, the elastic supporting portion 11f of the eccentric cam 11 is positioned inside the concavity 12d of the external gear 12 to elastically press the bottom of the concavity 12d in the rightward axial direction. Therefore, the annular flange 12e is in elastic contact with the side face of the internal gear 9d to prevent the external teeth 12c and the internal teeth 9e from being disengaged in the axial direction.

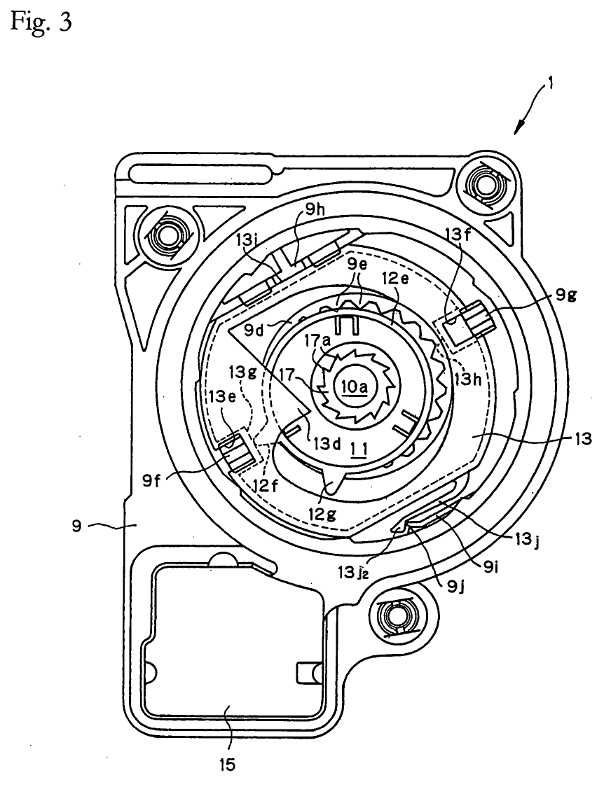

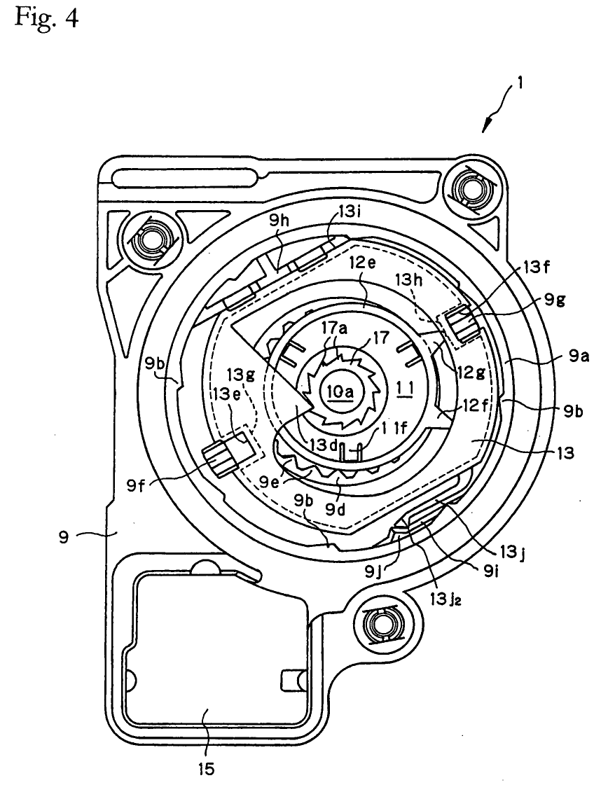

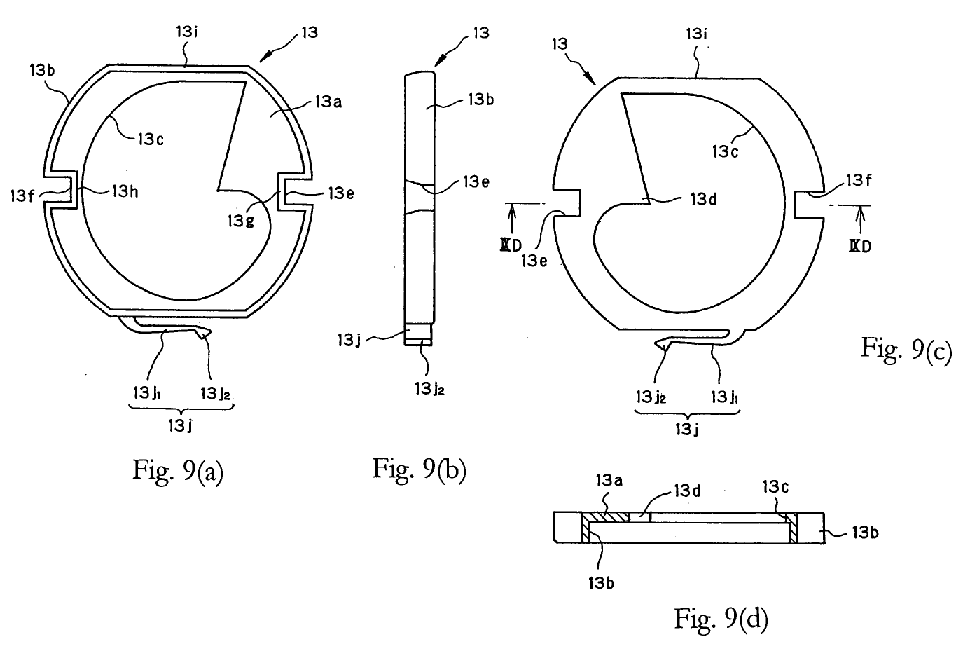

As shown in FIG. 2 through FIG. 4, an ALR actuating lock member 13 is disposed in the retainer 9 such that the lock member 13 is positioned within the W/S ratchet gear 9a. As shown in FIGS. 9(a) through 9(c), the ALR actuating lock member 13 has a plate portion 13a and a flange portion 13b formed all around the outer periphery of the plate portion to project therefrom. The plate portion 13a is provided with a σ-like through hole 13c formed therein and an engaging protrusion 13d formed on the inner periphery of the through hole 13c. Further, the ALR actuating lock member 13 is provided with a pair of guide grooves 13e, 13f which are formed at the outer edge thereof, respectively. These guide grooves 13e, 13f are fitted to the pair of guide projections 9f, 9g of the retainer 9 such that the guide grooves 13e, 13f can slide along the line connecting the centers of the guide projections 9f, 9g (shown in FIG. 3 and FIG. 4). Therefore, the ALR actuating lock member 13 is supported by the retainer such that the ALR actuating lock member 13 can move linearly along the line connecting the centers of the guide projections 9f, 9g.

On the inner wall of the guide grooves 13e, 13f, an ELR setting pressed portion 13g and an ALR setting pressed portion 13h are formed, respectively. As shown in FIG. 3, in the state that the ELR setting pressed portion 13g is pressed by the ELR setting switch 12f, the engaging protrusion 13d does not engage any of after-mentioned ratchet teeth 17a of an ALR actuating lock gear 17 so that the seat belt retractor 3 is set to the ELR mechanism mode. On the other hand, as shown in FIG. 4, in the state that the ALR setting pressed portion 13h is pressed by the ALR setting switch 12g, the engaging protrusion 13d engages one of the ratchet teeth 17a so that the seat belt retractor 3 is set to the ALR mechanism mode. That is, the ALR actuating lock member 13 and the ALR actuating lock gear 17 cooperate together to compose a lock switching mechanism.

Further, on the outer edge of the ALR actuating lock member 13, a flat guide face 13i is formed. The guide face 13i is in contact with the guide member 9h of the retainer 9 such that the guide face 13i can slide relative to the guide member 9h. The guide face 13i stably guides the ALR actuating lock member 13 when the ALR actuating lock member 13 moves linearly relative to the retainer 9.

Furthermore, an elastic positioning member 13j is formed on the outer edge of the ALR actuating lock member 13. The elastic positioning member 13j comprises an elastic arm 13j1 and a triangular engaging claw 13j2 which is formed on the end of the elastic arm 13j1. The engaging claw 13j2 can be engaged with the stopper 9j of the retainer 9 and is elastically pressed to the position control member 9i. In this case, the reaction force of the engaging claw 13j2 because the engaging claw 13j2 is pressed to the position control member 9i is supported by the guide member 9h.

The engaging claw 13j2 can move between the inoperative position on the left side of the stopper 9j as shown in FIG. 3 for holding the ALR actuating lock member 13 to the state where the mode of exhibiting the ELR mechanism is set and the operative position on the right side of the stopper 9j as shown in FIG. 4 for holding the ALR actuating lock member 13 to the state where the mode for exhibiting the ELR mechanism is set. In this case, the stopper 9j of the position control member 9i and the engaging claw 13j2 of the elastic positioning member 13j cooperate together to provide a holding system. During the movement of the engaging claw 13j2 between the inoperative position and the operative position, the elastic arm 13j1 elastically bows so as to allow the engaging claw 13j2 to cross the stopper 9j. The plate portion 13a, the flange portion 13b, and the engaging protrusion 13d are formed integrally as a single member.

As shown in FIG. 2, a lock gear 14 is supported by the rotary shaft portion 10a as one end of the spool 10. Further, a deceleration sensing system 15 is disposed on a side wall 8a of the base frame 8. Furthermore, a pawl 16 is pivotally disposed on the spool 10 and internal teeth 8b which can be engaged with the pawl 16 are formed in the side wall 8a. An inertia mass body of the webbing sensor having an engaging claw which can engage the ratchet teeth 9b of the retainer 9 is swingably disposed on the lock gear 14, but illustration of the inertia mass body is omitted. The lock gear 14, the deceleration sensing system 15, the pawl 16, the inner teeth 8b, and inertia mass body cooperate together to conduct the actuation of the ELR.

That is, as a large deceleration is applied to the vehicle in the event of a vehicle collision or the like, the deceleration sensing system 15 senses the large deceleration so as to lock the rotation in the belt withdrawing direction of the lock gear 14. On the other hand, the spool 10 is biased to rotate in the belt withdrawing direction by inertia movement of the occupant. Therefore, the pawl 16 pivots and thus engages with internal teeth of the side wall 8a so as to lock the rotation of the spool 10 in the belt withdrawing direction, thereby preventing the seat belt 4 from being withdrawn. As the seat belt 4 is withdrawn at a withdrawing speed significantly larger than the withdrawing speed for normally wearing the seat belt 4, the inertia mass body pivots because of inertia delay so as to engage the ratchet teeth 9b. Therefore, the rotation in the belt withdrawing direction of the lock gear 14 is locked, thereby locking the rotation in the belt withdrawing direction of the spool 10 as before.

The structures and actions of the lock gear 14, the deceleration sensing system 15, the pawl 16, the internal teeth 8b, and the inertia mass body are well known in the art and are similar to those described in Japanese Patent Applications JP-A-7-144605, JP-A-7-144606 and JP-A-2001-213275.

In the seat belt retractor 3 of this embodiment, the ALR actuating lock gear 17 is formed integrally with the lock gear 14 as shown in FIG. 2. As shown in FIG. 3 and FIG. 4, the ALR actuating lock gear 17 has a predetermined number of ratchet teeth 17a. Since the engaging protrusion 13d of the ALR actuating lock member 13 engages one of the ratchet teeth 17a as shown in FIG. 4 when the seat belt retractor is set in the ALR mechanism mode, the rotation in the belt withdrawing direction of the lock gear 14 is locked. Accordingly, similarly to the actuation of the ELR as mentioned above, the pawl 16 engages the internal teeth 8b so as to lock the rotation in the belt withdrawing direction of the spool 10, thereby conducting the AlR operation.

Now, description will be made as regard to the switching actions between the ELR mode and the ALR mode in the seat belt retractor according to this embodiment having the structure mentioned above. According to an exemplary embodiment, the entire length means the full length of the seat belt 4 capable of being wound and the full length of the seat belt 4 capable of being withdrawn.

As shown in FIG. 3, when the entire length of the seat belt 4 is wound, the seat belt retractor is set in such a state that the ELR setting switch 12f presses the ELR setting pressed portion 13g. In this state, the engaging protrusion 13d of the ALR actuating lock member 13 does not engage any of the ratchet teeth 17a of the ALR actuating lock gear 17 so that the ALR actuating lock member 13 is in the inoperative state. Therefore, the seat belt retractor 3 is set in the ELR mechanism mode. In addition, the engaging claw 13j2 is in the inoperative position (that is, non-lock position) and is thus engaged with the left side of the stopper 9j, whereby the ALR actuating lock member 13 is held in the inoperative position.

As the occupant pulls the seat belt 4 for wearing the seat belt 4 from the state that the entire length of the seat belt 4 is wound, the spool 10 rotates in the clockwise direction in FIG. 3. Accordingly, the eccentric cam 11 rotates together with the spool 10 in the same direction. By the rotation of the eccentric cam 11, the external gear 12 rotates at a reduced speed in a direction opposite to the rotational direction of the spool 10 (that is, the counterclockwise direction). By the rotation of the external gear 12, the ELR setting switch 12f comes off the ELR setting pressed portion 13g. Since the engaging claw 13j2 is in the inoperative position, i.e. on the left side of the stopper 9j, however, the ALR actuating lock member 13 is kept in the inoperative position. Until the seat belt 4 is withdrawn by a preset withdrawing amount (for example, the entire length or substantially the entire length), the inoperative state of the ALR actuating lock member 13 is held by the engaging claw 13j2 and the stopper 9j so that the seat belt retractor 3 is set in the ELR mechanism mode. As the occupant takes off the seat belt from this state, the entire length of the seat belt 4 is wound onto the spool 10.

As the seat belt 4 is withdrawn by an amount nearly the preset amount, the external gear 12 rotates by a predetermined amount in the counterclockwise direction so that the ALR setting switch 12g comes in contact with the ALR setting pressed portion 13h. As the seat belt 4 is further withdrawn, the external gear 12 further rotates in the counterclockwise direction so that the ALR setting switch 12g presses the ALR setting pressed portion 13h. As the pressing force by the ALR setting switch 12g exceeds a predetermined value, the elastic arm 13j1 elastically bows so that the engaging claw 13j2 crosses the stopper 9j. Therefore, the ALR actuating lock member 13 moves. Since the ALR actuating lock member 13 is lightly pressed onto the guide member 9h by the elastic positioning member 13j, the ALR actuating lock member 13 is always guided by the guide member 9h and thus can smoothly and stably move.

When the seat belt 4 is withdrawn by the preset amount as shown in FIG. 4, the ALR setting switch 12g is in a state pressing the ALR setting pressed portion 13h at the center of the same. In this state, the engaging protrusion 13d of the ALR actuating lock member 13 engages one of the ratchet teeth 17a so that the ALR actuating lock member 13 is in the operative state. Since the ALR actuating lock member 13 is guided by the guide member 9h, engagement between the engaging protrusion 13d and the ratchet teeth 17a is prevented from shifting in timing. In this manner, the seat belt retractor 3 is set in the ALR mechanism mode. At this point, the engaging claw 13j2 is in the operative position and is thus engaged with the right side of the stopper 9j so that the ALR actuating lock member 13 is kept in the operative state.

In the state where the seat belt retractor 3 is set in the ALR mechanism mode, the engaging protrusion 13d engages one of the ratchet teeth 17a so as to prevent the seat belt from being withdrawn, that is, the seat belt retractor 3 exhibits the ALR mechanism until the seat belt 4 is wound onto the spool 10 by the predetermined amount similarly to the conventional ALR.

As the spool 10 is rotated in the belt winding direction (that is, the counterclockwise direction) by a wind-up spring, not shown, after the seat belt retractor 3 is set in the ALR mechanism mode as shown in FIG. 4, the eccentric cam 11 rotates together with the spool 10 in the same direction. By the rotation of the eccentric cam 11, the external gear 12 rotates at a reduced speed in a direction opposite to the rotational direction of the spool 10 (that is, the clockwise direction). By the rotation of the external gear 12, the ALR setting switch 12g comes off the ALR setting pressed portion 13h. Since the engaging claw 13j2 is in the operative position, i.e. on the right side of the stopper 9j, however, the ALR actuating lock member 13 is kept in the operative position. Until the seat belt 4 is wound by a preset winding amount, the operative state of the ALR actuating lock member 13 is held by the engaging claw 13j2 and the stopper 9j so that the seat belt retractor 3 is set in the ALR mechanism mode.

As the seat belt 4 is wound by an amount nearly the preset amount, the external gear 12 rotates by a predetermined amount in the clockwise direction so that the ELR setting switch 12f comes in contact with the ELR setting pressed portion 13g. As the seat belt 4 is further wound, the external gear 12 further rotates in the clockwise direction so that the ELR setting switch 12f presses the ELR setting pressed portion 13g. As the pressing force by the ELR setting switch 12f exceeds a predetermined value, the elastic arm 13j1 elastically bows so that the engaging claw 13j2 crosses the stopper 9j. Therefore, the ALR actuating lock member 13 moves. When the seat belt 4 is wound by the preset amount as shown in FIG. 3, the ELR setting switch 12f is in a state pressing the ELR setting pressed portion 13g at the center of the same. In this state, the engaging protrusion 13d of the ALR actuating lock member 13 comes off the ratchet teeth 17a so that the ALR actuating lock member 13 is in the inoperative state. In this manner, the seat belt retractor 3 is set in the ELR mechanism mode again. At this point, the engaging claw 13j2 is in the inoperative position and is thus engaged with the left side of the stopper 9j so that the ALR actuating lock member 13 is held in the inoperative state.

According to the seat belt retractor 3 of this embodiment, the ALR actuating lock member 13 moves linearly between the inoperative position and the operative position, thereby stably, easily, and precisely controlling the operation of the ALR actuating lock member 13.

Since the lock switching mechanism composed of the ALR actuating lock member 13 and the ALR actuating lock gear 17 are arranged inside the annular W/S ratchet gear 9a as an annular member of the ELR, thereby making the seat belt retractor 3 small. Especially, since the ALR actuating lock member 13 is adapted to move linearly, the lock switching mechanism can be more efficiently arranged inside the W/S ratchet gear 9a.

Since the lock switching mechanism is composed of the ALR actuating lock member 13 and the ALR actuating lock gear 17, it is possible to reduce the number of parts as compared to the ALR actuating lock mechanism disclosed in Japanese Patent Application JP-A-2001-213275, thereby making the seat belt retractor 3 at a lower cost.

Further, since the ALR actuating lock member 13 is guided by the guide member 9h during the linear movement of the ALR actuating lock member 13, it is possible to smoothly and stably move the ALR actuating lock member 13. Therefore, the engagement between the engaging protrusion of the ALR actuating lock member 13 and the ratchet teeth 17a of the ALR actuating lock gear 17 is prevented from shifting in timing.

Furthermore, since the external gear 12, the ELR setting switch 12f, and the ALR setting switch 12g are formed integrally as a single member, it is possible to make the structure simple. In addition, the ELR setting switch 12f is adapted to press only the ELR setting pressed portion 13g and the ALR setting switch 12g is adapted to press only the ALR setting pressed portion 13h, thereby eliminating the precise adjustment for the respective positions and heights of the ELR setting switch 12f and the ALR setting switch 12g. Accordingly, the ELR setting switch 12f and the ALR setting switch 12g can be easily manufactured.

Moreover, the ALR actuating lock member 13 can be held in the state disengaged from the ALR actuating lock gear 17 and can also be held in the state engaged with the ALR actuating lock gear 17 by the position control member 9i and the elastic positioning member 13j which are the holding system, thereby stably holding the ALR actuating lock member 13 in any of both setting positions.

Though the ALR actuating lock member 13 is provided with a σ-like through hole 13c formed in the center thereof and is thus formed in an annular shape in the aforementioned embodiment, the ALR actuating lock member 13 comprises two arms 13k, 13m and a connecting portion 13n connecting the arms 13k, 13m in the seat belt retractor 3 of this embodiment. In this case, the arms 13k, 13m extend from the connecting portion 13n such that the space between the distal ends of the arms 13k, 13m is wider than the space between the proximal ends thereof. The arms 13k, 13m are provided with guide holes 13e, 13f (the same numerals as the guide grooves 13e, 13f are used for ease of explanation) formed in the distal end portions thereof, respectively. These guide holes 13e, 13f are fitted to the guide projections 9f, 9g, respectively and are guided by the guide projections 9f, 9g and the guide member 9h so that the ALR actuating lock member 13 move linearly. One of the arms, i.e. the arm 13k, is provided with an engaging protrusion 13d. The engaging protrusion 13d can engage one of the ratchet teeth 17a of the ALR actuating lock gear 17.

Other structures of the seat belt retractor 3 of this embodiment are the same as those of the aforementioned embodiment. The works and effects of the seat belt retractor 3 of this embodiment are substantially the same as those of the aforementioned embodiment.

The seat belt retractor is not limited to the aforementioned embodiments and various design changes may be made within a scope of the claims of the present invention.

The priority application, Japanese Patent Application 2008-187281, filed Jul. 18, 2008 including the specification, drawings, claims and abstract, is incorporated herein by reference in its entirety.

What is claimed is:

1. A seat belt retractor comprising:
an emergency locking retractor mechanism for locking the rotation in the belt withdrawing direction of a spool, onto which a seat belt is wound, according to actuation of at least one of the deceleration sensing system and a webbing sensor;
an automatic locking retractor automatic locking retractor mechanism for locking the rotation in the belt withdrawing direction of the spool when the seat belt is withdrawn by a predetermined length; and a lock switching mechanism for switching and setting between a mode exhibiting the emergency locking retractor mechanism and a mode exhibiting the automatic locking retractor mechanism;
wherein the lock switching mechanism comprises an automatic locking retractor mechanism actuating lock member, and an automatic locking retractor mechanism actuating lock gear which locks the rotation in the belt withdrawing direction of the spool when the automatic locking retractor mechanism actuating lock member is engaged; and
wherein the automatic locking retractor mechanism actuating lock member is engaged with and is disengaged from the automatic locking retractor mechanism actuating lock gear by linear movement.

2. A seat belt retractor as claimed in claim 1, wherein the lock switching mechanism is arranged inside an annular member of the emergency locking retractor mechanism.

3. A seat belt retractor as claimed in claim 1, further comprising a guide member for guiding the automatic locking retractor mechanism actuating lock member during the linear movement of the automatic locking retractor mechanism actuating lock member.

4. A seat belt retractor as claimed in claim 1, further comprising: an internal gear; and an external gear which is meshed with the internal gear and rotates eccentrically at a reduced speed according to the rotation of the spool,
wherein the external gear has an emergency locking retractor mechanism setting switch and an automatic locking retractor mechanism setting switch; and
wherein the automatic locking retractor mechanism actuating lock member is pressed by one of the emergency locking retractor mechanism setting switch and the automatic locking retractor mechanism setting switch so as to linearly move.

5. A seat belt retractor as claimed in claim 4, wherein the emergency locking retractor mechanism setting switch presses only an emergency locking retractor mechanism setting pressed portion of the automatic locking retractor mechanism actuating lock member so as to move the automatic locking retractor mechanism actuating lock member linearly such that the automatic locking retractor mechanism actuating lock member is disengaged from the automatic locking retractor mechanism actuating lock gear, and
wherein the automatic locking retractor mechanism setting switch presses only an automatic locking retractor mechanism setting pressed portion of the automatic locking retractor mechanism actuating lock member so as to move the automatic locking retractor mechanism actuating lock member linearly such that the automatic locking retractor mechanism actuating lock member is engaged with the automatic locking retractor mechanism actuating lock gear.

6. A seat belt retractor as claimed in claim 4, wherein the external gear, the emergency locking retractor mechanism setting switch, and the automatic locking retractor mechanism setting switch are formed integrally as a single member.

7. A seat belt retractor as claimed in claim 1, further comprising a holding system which holds the automatic locking retractor mechanism actuating lock member in its disengaged state when the automatic locking retractor mechanism actuating lock member is disengaged from the automatic locking retractor mechanism actuating lock gear, and holds the automatic locking retractor mechanism actuating lock member in its engaged state when the automatic locking retractor mechanism actuating lock member is engaged with the automatic locking retractor mechanism actuating lock gear.

8. A seat belt apparatus comprising
a seat belt retractor comprising:
an emergency locking retractor mechanism for locking the rotation in the belt withdrawing direction of a spool, onto which a seat belt is wound, according to actuation of at least one of the deceleration sensing system and a webbing sensor;
an automatic locking retractor automatic locking retractor mechanism for locking the rotation in the belt withdrawing direction of the spool when the seat belt is withdrawn by a predetermined length; and a lock switching mechanism for switching and setting between a mode exhibiting the emergency locking retractor mechanism and a mode exhibiting the automatic locking retractor mechanism;
wherein the lock switching mechanism comprises an automatic locking retractor mechanism actuating lock member, and an automatic locking retractor mechanism actuating lock gear which locks the rotation in the belt withdrawing direction of the spool when the automatic locking retractor mechanism actuating lock member is engaged; and
wherein the automatic locking retractor mechanism actuating lock member is engaged with and is disengaged from the automatic locking retractor mechanism actuating lock gear by linear movement;
a tongue which is slidably supported on the seat belt withdrawn from the seat belt retractor; and
a buckle which is detachably latched with the tongue;
wherein the seat belt is prevented from being withdrawn by the seat belt retractor in the event of an emergency so as to restrain an occupant.
